(19) United States
(12) Patent Application Publication
(10) Pub. No.: US 2026/0138149 A1
(43) Pub. Date: May 21, 2026

(54) INTEGRATED CONNECTORS FOR SECURING INTERCHANGEABLE JET MODULES WITHIN A SPA AND/OR BATHING SYSTEM

(71) Applicant: BULLFROG INTERNATIONAL, LC, Herriman, UT (US)

(72) Inventors: Richard Alex Eddington, South Jordan, UT (US); Michael Andersen, American Fork, UT (US); Cory Shorr, Pine Canyon, UT (US); Mark McLane, Lehi, UT (US)

(21) Appl. No.: 19/386,606

(22) Filed: Nov. 12, 2025

Related U.S. Application Data
(60) Provisional application No. 63/721,166, filed on Nov. 15, 2024.

(51) Int. Cl. B05B 15/65; A47K 3/10

(52) U.S. Cl. CPC B05B 15/65; A47K 3/10

(57) ABSTRACT

This disclosure relates generally to an integrated connector for securing an interchangeable jet module within a spa. The integrated connector may include a first portion defining a hole for receiving a water connector disposed at a bottom of the interchangeable jet module, the first portion forming a bulkhead fitting. A second portion may extend vertically from the first portion, the second portion having an engagement feature for engaging the interchangeable jet module. The integrated connector may be disposed in a hollow of the spa, where the interchangeable jet module is secured within the hollow through the integrated connector.

### CLAIM FOR PRIORITY

A claim for priority to the November 15, 2024 filing date of U.S. Provisional Application No. 63/721,166 titled “INTEGRATED CONNECTORS FOR SECURING INTERCHANGEABLE JET MODULES WITHIN A SPA AND/OR BATHING SYSTEM,” (the “’166 Provisional Application”) is hereby made pursuant to 35 U.S.C. §119(e). The entire disclosure of the ’166 Provisional Application is herein incorporated by reference.

### TECHNICAL FIELD

This disclosure relates generally to integrated connectors for securing interchangeable jet modules within a spa, wherein the integrated connectors both secure the interchangeable jet modules within the spa and provide access to a main flow of water for the jet modules.

### SUMMARY

Disclosed are systems, devices, and/or methods of use thereof regarding integrated connectors for securing interchangeable jet modules within a spa, where the integrated connectors both secure the interchangeable jet modules within the spa and provide access to a main flow of water for the jet modules. In various aspects, an integrated connector for securing an interchangeable jet module within a spa includes a first portion defining a void for receiving a water connector disposed at a bottom of the interchangeable jet module. The integrated connector may also include a second portion extending vertically from the first portion, with the second portion having an engagement feature that is capable of engaging the interchangeable jet module with sufficient force to keep the interchangeable jet module locked onto the integrated connector in a locked position and ejected in an unlocked position, the interchangeable jet module capable of being changed from the locked position to the unlocked position without the use of tools. The integrated connector may be disposed in a hollow of the spa, where the interchangeable jet module is secured within the hollow through the integrated connector.

In various aspects, a system for securing an interchangeable jet module within a spa may include an integrated connector. The integrated connector may include a first portion defining a void for receiving a water connector disposed at a bottom of the interchangeable jet module. The integrated connector may also include a second portion extending vertically from the first portion, with the second portion having a hook for engaging the interchangeable jet module. The system may also include a gasket in connection with the first portion, where the gasket may be positionable between the first portion of the integrated connector and the water connector of the interchangeable jet module.

In various aspects, an interchangeable jet module for installation within a spa includes a manifold having a plurality of air and water chambers, and a jet plate connected to the manifold. The jet plate may have a plurality of jets for delivering air and water from the plurality of air and water chambers into the spa. The interchangeable jet module may also include a lock integrated at a bottom of the manifold, wherein the lock is for selectively engaging a bulkhead fitting of the spa. Further, the interchangeable jet module may include a gasket in association with the lock, wherein the gasket is for sealing a connection between the manifold and the bulkhead fitting of the spa.

In various aspects, a method of manufacturing an integrated connector includes forming a first portion of a fitting from a thermoplastic material and forming a second portion of the fitting from the thermoplastic material. The first portion may define a void to receive a bottom of a jet module and the second portion may extend vertically from the first portion. The first portion and the second portion may be or form a unitary structure and form the integrated connector.

In various aspects, a method of installing an interchangeable jet module within a spa includes aligning a water connector disposed at a bottom of the interchangeable jet module over a bulkhead fitting of the spa. The method may also include pressing the water connector into the bulkhead fitting of the spa, with the bulkhead fitting placing the water connector into fluid communication with a flow of water in the spa. Further, the method may include snapping a ridge of the interchangeable jet module into an engagement feature of the bulkhead fitting, thereby securing the interchangeable jet module within the spa. The engagement feature may be capable of engaging the interchangeable jet module with sufficient force to keep the interchangeable jet module locked onto the bulkhead fitting in a locked position and ejected or disengaged from the bulkhead fitting in an unlocked position, and the interchangeable jet module may be changed from the locked position to the unlocked position without the use of tools, or in other words, by hand or manual actuation.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

### In the drawings:

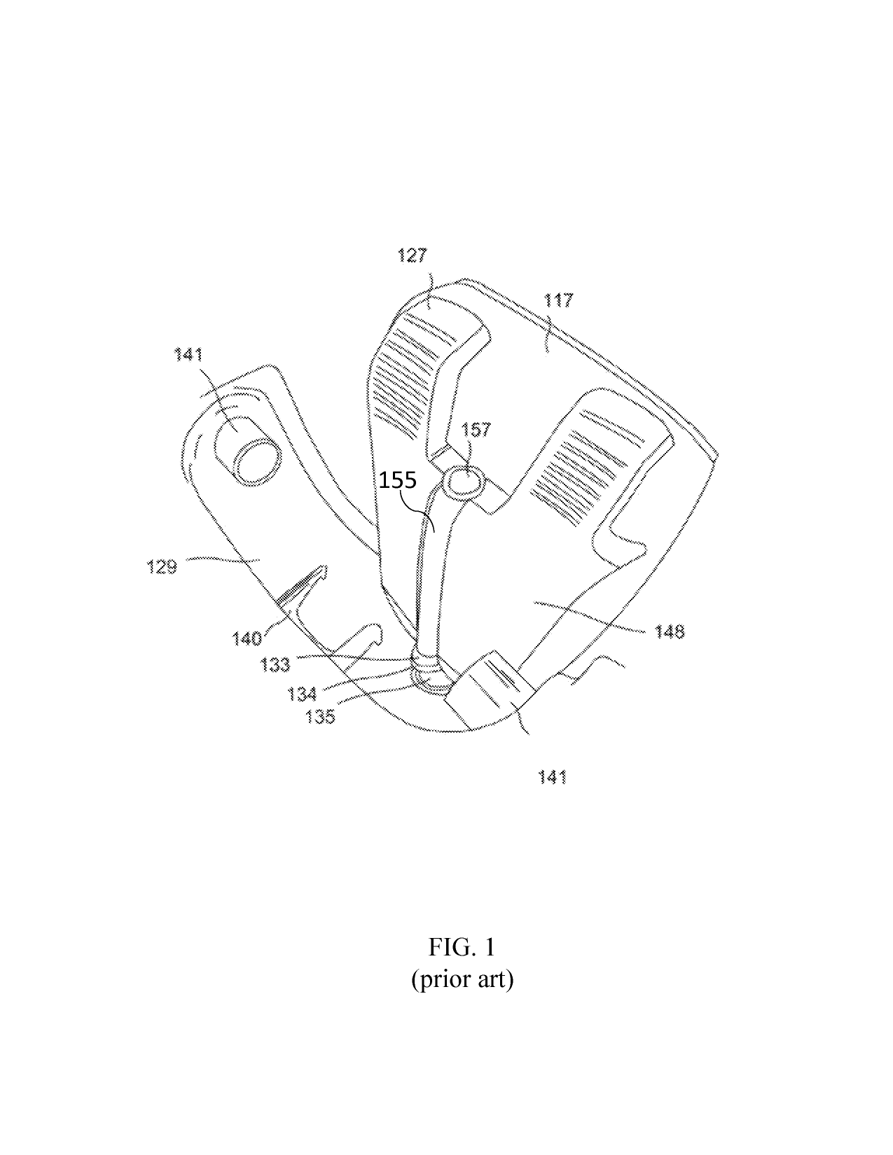

FIG. 1 illustrates a partially exploded, perspective view of prior art methods of attaching and securing an interchangeable jet module to a spa or bathing system;

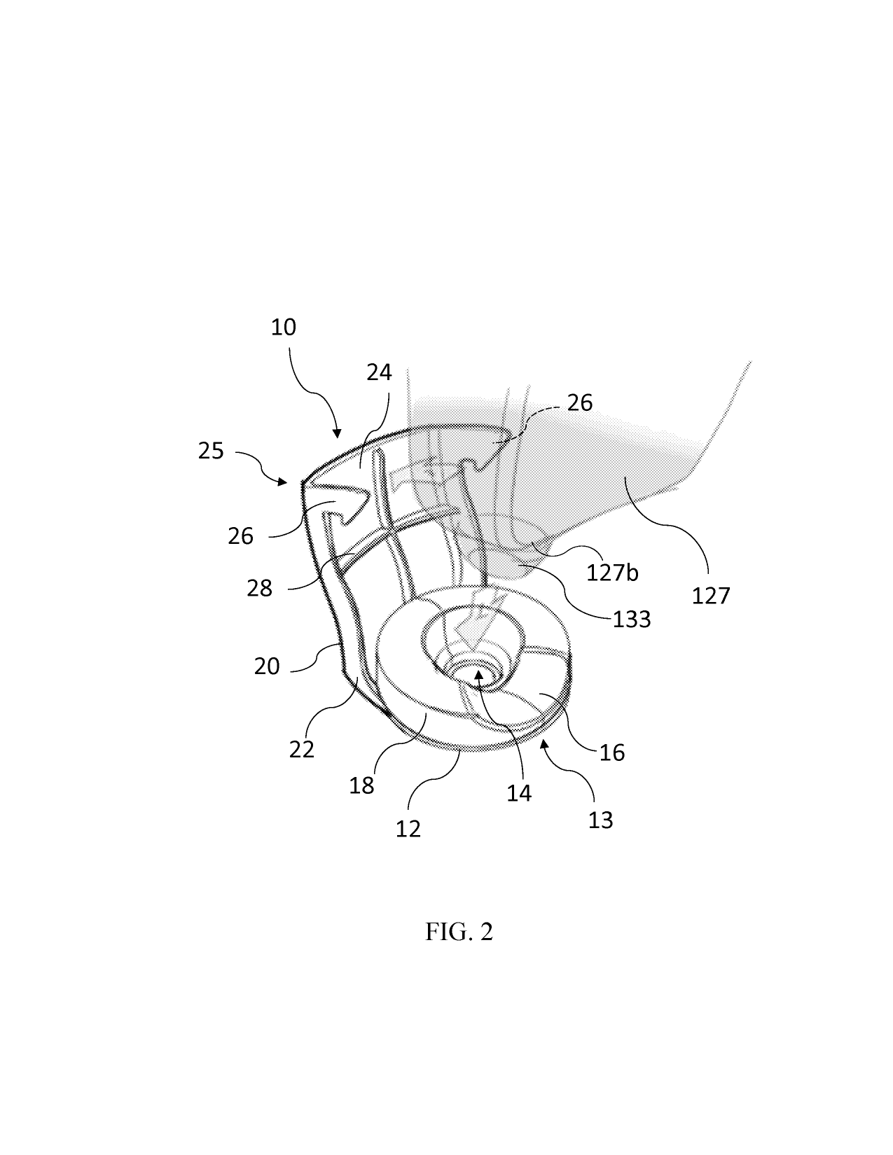

FIG. 2 illustrates a perspective view of an integrated connector for securing an interchangeable jet module to a spa or bathing system;

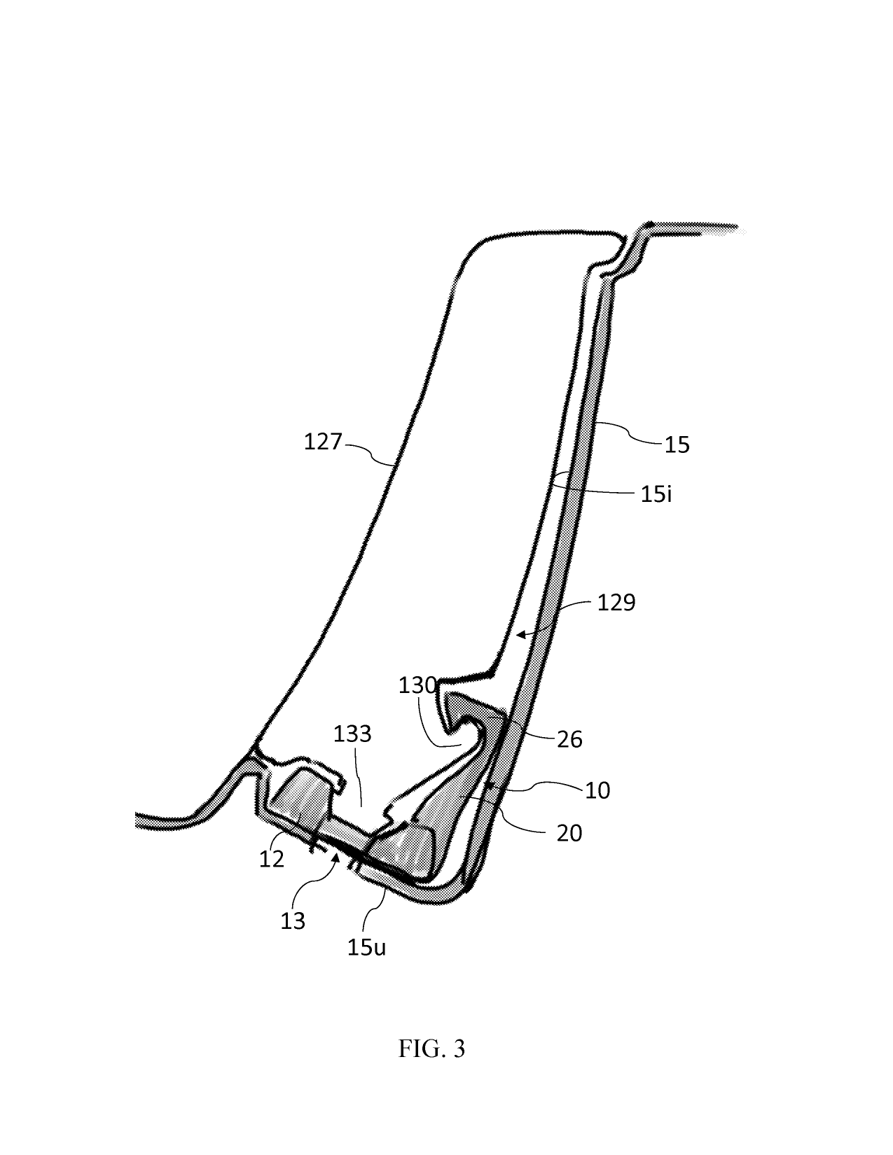

FIG. 3 illustrates a side, cross-sectional view of the interchangeable jet module having been secured to the spa through the integrated connector of FIG. 2;

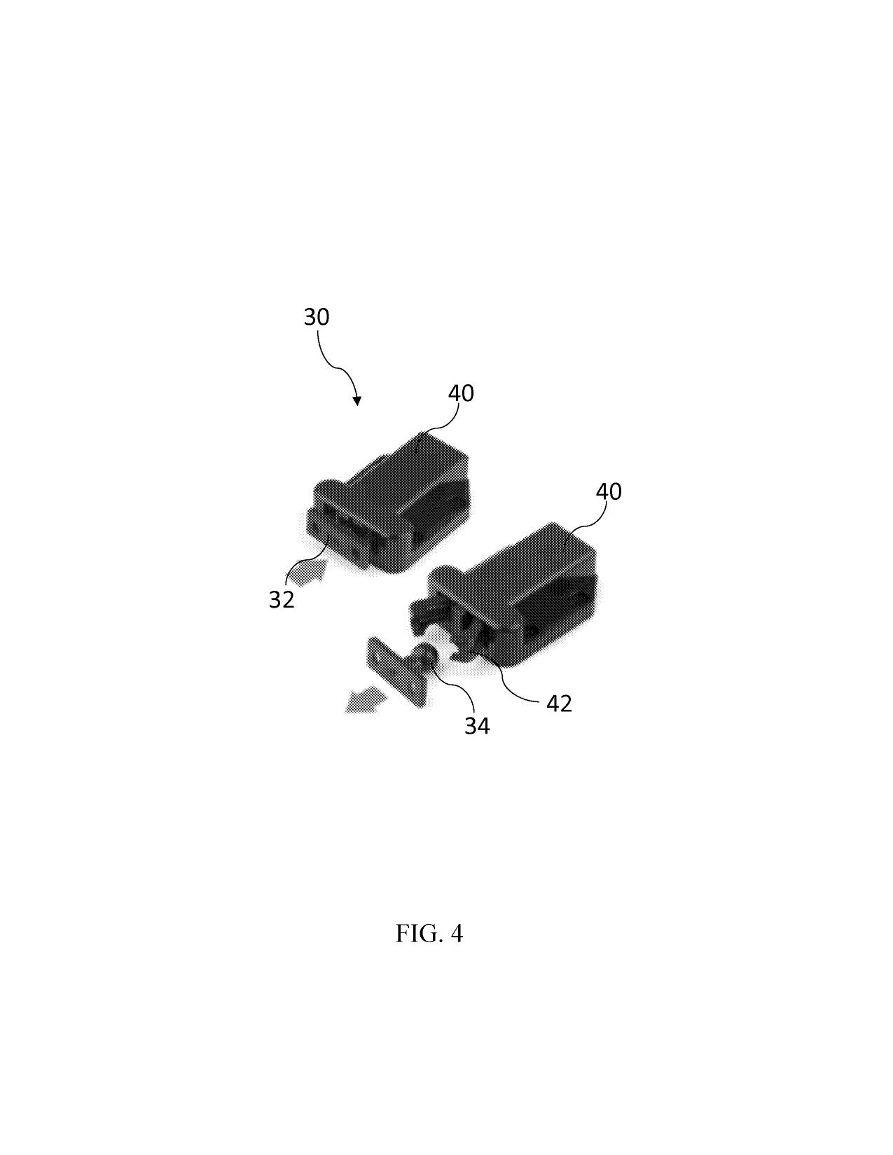

FIG. 4 illustrates another embodiment of an integrated connector for securing an interchangeable jet module to a spa or bathing system;

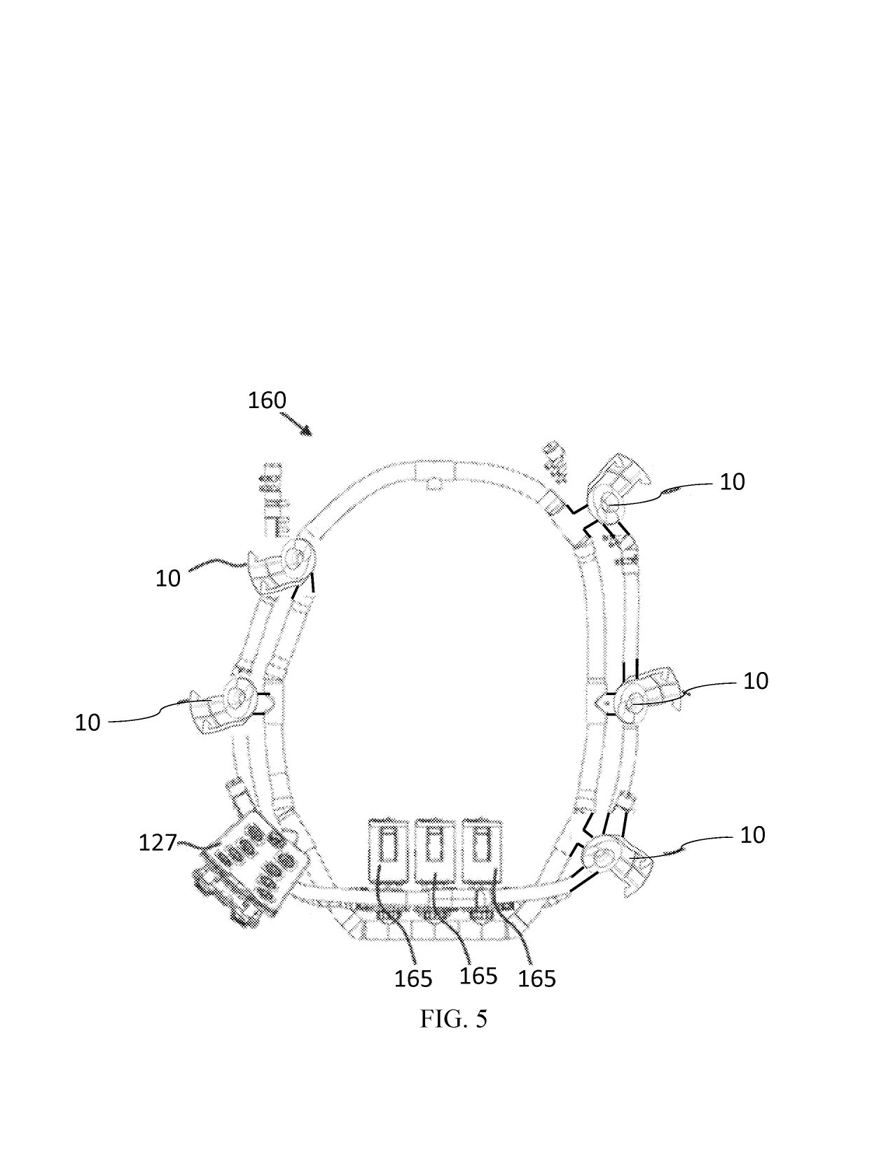

FIG. 5 schematically illustrates a spa or bathing system;

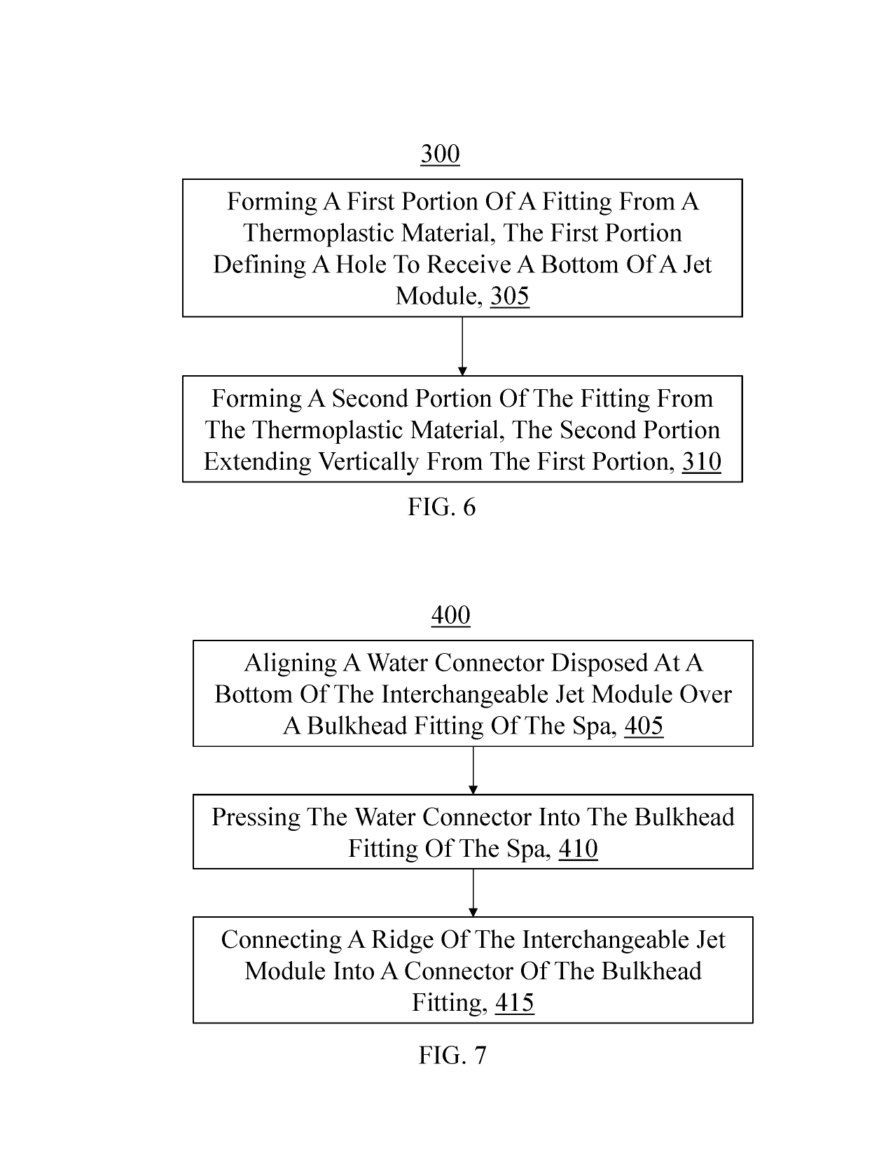

FIG. 6 is a flowchart of an example method of manufacturing the integrated connector of FIG. 2; and

FIG. 7 is a flowchart of an example method of installing an interchangeable jet module within a spa using the disclosed integrated connector.

### DETAILED DESCRIPTION

In modular systems, a shell or spa containment is constructed with depressions or hollows in a shell wall. Each of the hollows may be interchangeably fitted with a jet module that comprises a plate upon which jets are mounted for injecting water into the spa shell. One or more water inlets extend through the spa shell to provide water for the jets. The water inlets may communicate water from a water supply, through the water inlets, and expelled from the jets in the jet module. Air is also supplied to the module from an air inlet and air supply. The flow of air and water through the jets, in isolation or combination, may be controlled to provide the user with a desired flow rate and corresponding sensation (e.g., massaging, bubbling, etc.).

The jet modules may be secured within the hollows through a bulkhead fitting disposed within the hollows. The bulkhead fitting may connect the jet modules with the main water flow of the spa. The jet modules may be threaded into the bulkhead fittings and unscrewed to remove the jet modules as needed. Alternatively, jet modules may be engaged with the bulkhead fittings, with a gasket in place between the bulkhead fitting and a latch. The latch is typically a rigid part installed along a spine of the jet module shell about ¾ of the way up, such that when the jet module is engaged with the bulkhead fitting, the jet module is engaged below the latch and provides sufficient downward pressure to seal the gasket.

One of the prevailing issues with the latch design is that it has to be installed independent from the bulkhead fitting. This introduces tolerance stacking issues both with the distance between the bulkhead fitting and the latch, but also in the module itself since there are multiple parts assembled together between those two features. This tolerance stacking can end up causing the module to be either too loose in the hollow, or too tight. If the module is too loose or too tight in the hollow, this can result in insufficient flows of water and air through the module, meaning a user may not achieve the desired flow rate and corresponding sensation.

For example, FIG. 1 illustrates an exploded, perspective view of prior art methods of attaching and securing an interchangeable jet module 127 to a spa or bathing system. As shown, a water connector 133 of the jet module 127 is being inserted into a water port 135 of a hollow 129 of the spa. Water is supplied through the water port 135 and water connector 133, into the manifold 148, and then into jets that are part of the jet module 127. O-ring 134 may be associated with the water port 135 and may be used to provide a solid seal between the water port 135 and water connector 133. The water port 135 may be a bulkhead fitting.

The hollow 129 includes a latch 140 for engaging a spine 155 extending vertically up and outwardly from the manifold 148 of the jet module 127. The hollow 129 also includes shoulders 141 extending from the sides of the hollow 129 that may be used for adjoining accessories to the jet module 127. While the prior art system of FIG. 1 utilizes an O-ring 134 to help seal the connection between the water port 135 and water connector 133, the system is susceptible to tolerance issues, leading to either a too tight or too loose fit of the jet module 127 within the hollow 129.

FIGS. 2 and 3 illustrate an integrated connector 10 for securing an interchangeable jet module, such as the jet module 127 of FIG. 1, to a spa or bathing system. The connector 10 may form a bulkhead fitting for a spa and may be disposed within the spa, such as within a hollow 129 of a spa (see FIG. 3). The connector 10 includes a first portion 12 and a second portion 20 extending vertically from the first portion 12.

The first portion 12 has a body 18 that may define a void or hole 14 to receive a water connector 133 of the jet module 127. The first portion 12 may also include a ramp 16 to facilitate installation of the water connector 133 within the first portion 12. The void 14 may place the water connector 133, and therefore the jet module 127, in fluid communication with a water flow of the spa. This may allow water to be delivered internally to the jet module 127, and specifically to a manifold of the jet module 127, to then be expelled by one or more jets into the spa.

As seen in FIG. 2, the first portion 12 is substantially circular and, with the void 14 therethrough, may be torus-shaped. The first portion 12 forms a bulkhead fitting 13. Any suitable bulkhead fitting may be used, such as those bulkhead fittings disclosed in U.S. Patent No. 11,719,011, which is incorporated by reference herein in its entirety. For example, the bulkhead fitting 13 may create a secure, watertight seal through the spa shell 15, from an underside 15u of the spa shell and into the interior 15i of the spa shell. As seen in FIG. 3, the water connector 133 of the jet module 127 fits within the void 14 of the first portion 12. The body 18 of the bulkhead fitting 13 may supply a base or platform on which the bottom 127b of the jet module 127 may rest when the water connector 133 is received within the hole 14. When the jet module 127 is connected to the bulkhead fitting 13, it may create a secure, watertight connection through the spa shell 15, allowing water to flow from a pipe under the spa shell 15 and into the jet module 127.

The second portion 20 of the connector 10 extends vertically between a bottom 22 and a top 24. The bottom 22 of the second portion 20 is in association with the first portion 12. For example, the connector 10 may be formed of an integral piece, or it may be two separate pieces connected through appropriate means (e.g., hinge, snap, pin and detent, etc.). The second portion 20 may be substantially planar and rectangular. Alternatively, the second portion 20 may be substantially rectangular and have a shape or curvature corresponding to a shape and/or curvature of the jet module 127. The second portion 20 includes a connector or an engagement feature 25 for engagement of a portion of the jet module 127 (in one configuration, the engagement feature 25 is a hook for engaging a back of the jet module 127). The engagement feature 25 may be capable of engaging the interchangeable jet module 127 with sufficient force to keep the interchangeable jet module 127 locked onto the integrated connector in a locked position and ejected or disengaged from the integrated connector 10 in an unlocked position. The interchangeable jet module 127 may be transitioned from the locked position to the unlocked position without the use of tools, or in other words, by hand or manual actuation. Different types of engagement features 25 may be used, and in some examples, the engagement features 25 allow the interchangeable jet module 127 to be locked in place or retained and remain in the locked position until an actuation to move to the unlocked position, and the actuation to move to the unlocked position may be without tools.

For example, the jet module 127 may include complementary structures for engaging the connector 10. In one configuration, incorporated at and extending from the top 24 of the connector 10 are lateral wings 26 which may be shaped to engage a protrusion 130 at the back of the jet module 127. The second portion 20 may also include ridges 28 for additionally securing the jet module 127 to the connector 10 and the hollow 129 of the spa.

As seen most clearly in FIG. 3, the connector 10 may be disposed within the hollow 129 of the spa shell 15. The water connector 133 of the jet module 127 may be both secured in and released from the first portion 12 of the connector 10 through an actuation. In one configuration, the motion for securing the jet module 127 may be to first engage the water connector 133 with the bulkhead fitting 13 by pressing generally downwardly, and then secure the jet module 127 to the second portion 20 of the connector 10 by pressing generally backward (e.g., towards the spa shell 15) on the jet module 127.

FIG. 4 illustrates another embodiment of an integrated connector 30 for securing an interchangeable jet module, such as the module 127, to a spa or bathing system. The connector 30 includes a first portion 32 and a second portion 40. The first portion 32 may include a stud 34 for releasably engaging the second portion 40. The second portion 40 may include a lock 42 for engaging the stud 34 of the first portion 32. For example, the stud 34 may be inserted into the lock 42 and the lock 42 may securely engage the stud 34, thereby locking the first portion 32 to the second portion 40. The stud 34 may similarly be released from the lock 42 by actuating the second portion 40, which releases the lock 42 and the stud 34. This type of connector may allow the jet module 127 to engage with a snap-fit inside the bulkhead fitting 13. Cam locks, of which the connector 30 may be a type, typically operate by inserting the component into the locking feature, which then cams into a locking position. When the component is actuated, the camming action releases and allows the component to be withdrawn.

In some embodiments, the second portion 40 may be integrated into a bottom of the jet module 127 and the first portion 32 is integrated into a hollow 129 of a spa. The jet module 127 may be aligned over the hollow 129 of the spa, such that the lock 42 of the second portion 40 is aligned over the stud 34 of the first portion 32. The module 127 may then be pushed, causing the stud 34 to be pressed into the lock 42, thereby securing the first portion 32 to the second portion 40 and securing the jet module 127 within the hollow 129.

The jet module 127 may be similarly released from the hollow 129. That is, the jet module 127 may be actuated, causing the lock 42 to release the stud 34, thereby releasing the first portion 32 from the second portion 40 so that the jet module 127 may be released from the hollow 129. In this way, the jet module 127 may be engaged and disengaged. It will be appreciated that the parts of the connector 30 can also be reversed (i.e., the second portion 40 may be integrated into a hollow 129 of a spa and the first portion 32 may be integrated into a bottom of the jet module 127). The connector 30 may be used in any suitable location, such as at or near the bulkhead fitting 13, or at or near another location within the hollow 129. In some embodiments, the connector 30 is used in conjunction with the connector 10 to removably secure the interchangeable jet modules 127 to the spa.

FIG. 5 illustrates a top, plan view of a spa system 160 having a plurality of connectors 10 installed therein. As seen in FIG. 5, the connectors 10 may be positioned behind the jet module 127, and towards the base of the jet module 127 (FIG. 3). In this configuration, the connector 10 is not directly positioned in the portion of the spa tub that bathers use. Because the connector 10 is behind the jet module 127, water from the spa tub may be taken into the connector 10 only as it flows from the main spa tub behind, under, or otherwise around the jet module 127. This placement may increase the safety of the connector 10 by physically separating it from the portion of the main spa tub where bathers are located. The placement may also allow users to easily access the connector 10, for example, by removing the jet module 127. In other configurations, the connector 10 may be placed at a different location, either within the main spa tub or otherwise in fluid communication with the main spa tub. The connector 10 may connect to the shell of a spa through friction fit, snap fit, threads, etc. Pumps 165 may be included as part of the spa system 160 and may assist in moving air and water through the connectors 10 and the modules 127.

FIG. 6 is a flowchart of an example method 300 of manufacturing the integrated connector of FIG. 2. The method 300 may include forming a first portion of a fitting from a thermoplastic material, at 305, with the first portion defining a void to receive a bottom of a jet module (e.g., a water connector of the jet module). The method 300 may also include forming a second portion of the fitting from the thermoplastic material, at 310, with the second portion extending vertically from the first portion. The first portion and the second portion may be or form a unitary structure. The integrated connector may be formed through a blow-molding process, such that the first portion and the second portion are a unitary structure. Alternatively, the integrated connector may be formed through an injection-molding process, such that the first portion and the second portion are a unitary structure.

FIG. 7 is a flowchart of an example method 400 of installing an interchangeable jet module within a spa using the disclosed integrated connector (e.g., connector 10). The method 400 may include aligning a water connector disposed at a bottom of the interchangeable jet module over a bulkhead fitting of the spa, at 405. The method 400 may also include pressing the water connector into the bulkhead fitting of the spa, with the bulkhead fitting placing the water connector into fluid communication with a flow of water in the spa, at 410. Further, the method 400 may include connecting a ridge of the interchangeable jet module into a connector of the bulkhead fitting, thereby securing the interchangeable jet module within the spa, at 415.

### Embodiments

Embodiment 1. An integrated connector for securing an interchangeable jet module within a spa, the integrated connector comprising:

a first portion defining a void for receiving a water connector disposed at a bottom of the interchangeable jet module, the first portion forming a bulkhead fitting; and

a second portion extending vertically from the first portion, the second portion having an engagement feature that is capable of engaging the interchangeable jet module with sufficient force to keep the interchangeable jet module locked onto the integrated connector in a locked position and ejected in an unlocked position, the interchangeable jet module capable of being changed from the locked position to the unlocked position without the use of tools; and

the integrated connector disposed in a hollow of the spa, where the interchangeable jet module is secured within the hollow through the integrated connector.

Embodiment 2. The integrated connector of Embodiment 1, wherein the engagement feature of the second portion comprises a hook.

Embodiment 3. The integrated connector of Embodiment 2, wherein the hook comprises lateral wings, each lateral wing extending from a top of the second portion and each lateral wing being shaped to engage a back of the interchangeable jet module.

Embodiment 4. The integrated connector of Embodiment 2 or 3, wherein each lateral wing engages a protrusion on the back of the interchangeable jet module.

Embodiment 5. The integrated connector of any one of Embodiments 1 through 4, wherein the first portion is substantially circular with the void defined about a center of the first portion.

Embodiment 6. The integrated connector of any one of Embodiments 1 through 5, wherein the first portion is substantially torus-shaped.

Embodiment 7. The integrated connector of any one of Embodiments 1 through 6, wherein the first portion further comprises a ramp to facilitate connection of the water connector of the interchangeable jet module within the void.

Embodiment 8. The integrated connector of any one of Embodiments 1 through 7, wherein the second portion is substantially rectangular extending between a bottom end and a top end, the engagement feature being incorporated into the top end.

Embodiment 9. The integrated connector of any one of Embodiments 1 through 8, wherein the second portion is substantially rectangular, extending between a bottom end and a top end, and has a curvature substantially matching a back of the interchangeable jet module.

Embodiment 10. A system for securing an interchangeable jet module within a spa, the system comprising:

an integrated connector comprising:

a first portion defining a void for receiving a water connector disposed at a bottom of the interchangeable jet module; and

a second portion extending vertically from the first portion, the second portion having an engagement feature for engaging the interchangeable jet module.

Embodiment 11. The system of Embodiment 10, further comprising a gasket in connection with the first portion, the gasket positionable between the first portion of the integrated connector and the water connector of the interchangeable jet module.

Embodiment 12. The system of Embodiment 10 or 11, wherein the first portion is substantially torus-shaped with the void defined about a center of the first portion.

Embodiment 13. The system of any one of Embodiments 10 through 12, wherein the first portion and the second portion form a unitary structure.

Embodiment 14. The system of any one of Embodiments 10 through 13, wherein the engagement feature comprises lateral wings, each lateral wing extending from a top of the second portion and each lateral wing being shaped to engage the interchangeable jet module.

Embodiment 15. The system of any one of Embodiments 10 through 14, wherein the integrated connector disposed in a hollow of the spa, where the interchangeable jet module is secured within the hollow through the integrated connector.

Embodiment 16. An interchangeable jet module for installation within a spa, the interchangeable jet module comprising:

a manifold comprising a plurality of air and water chambers;

a jet plate connected to the manifold and comprising a plurality of jets for delivering air and water from the plurality of air and water chambers into the spa;

a lock integrated at a bottom of the manifold, the lock for selectively engaging a bulkhead fitting of the spa; and

a gasket in association with the bulkhead fitting, the gasket for sealing a connection between the manifold and the bulkhead fitting of the spa.

Embodiment 17. The interchangeable jet module of Embodiment 16, wherein the lock comprises a ball grab for engaging with a ball stud of the bulkhead fitting.

Embodiment 18. The interchangeable jet module of Embodiment 16 or 17, wherein the ball grab engages the ball stud with a press-fit and the ball grab releases the ball stud through an actuated release mechanism.

Embodiment 19. The interchangeable jet module of any one of Embodiments 16 through 18, wherein the lock comprises a water connector for engaging the bulkhead fitting of the spa.

Embodiment 20. The interchangeable jet module of any one of Embodiments 16 through 19, wherein the interchangeable jet module further comprises a protrusion on a back of the manifold for engaging an engagement feature extending vertically from the bulkhead fitting.

Embodiment 21. A method of manufacturing an integrated connector, the method comprising: forming a first portion of a fitting from a thermoplastic material, the first portion defining a void to receive a bottom of a jet module; and forming a second portion of the fitting from the thermoplastic material, the second portion extending vertically from the first portion, the first portion and the second portion being a unitary structure.

Embodiment 22. The method of Embodiment 21, wherein forming a first portion of a fitting from a thermoplastic material comprises blow-molding the first portion.

Embodiment 23. The method of Embodiment 21 or 22, wherein forming a first portion of a fitting occurs simultaneously with forming a second portion of the fitting.

Embodiment 24. A method of installing an interchangeable jet module within a spa, the method comprising: aligning a water connector disposed at a bottom of the interchangeable jet module over a bulkhead fitting of the spa; pressing the water connector into the bulkhead fitting of the spa, the bulkhead fitting placing the water connector into fluid communication with a flow of water in the spa; and connecting a portion of the interchangeable jet module onto an engagement feature of the bulkhead fitting, thereby securing the interchangeable jet module within the spa.

Embodiment 25. The method of Embodiment 24, further comprising removing the interchangeable jet module from the spa by disengaging the interchangeable jet module from the engagement feature of the bulkhead fitting without the use of tools.

### Additional Terms and Definitions

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It should also be noted that some of the embodiments disclosed herein may have been disclosed in relation to a particular water-containing vessel (e.g., a spa); however, other vessels (e.g., pools, tubs, swim spas, etc.) are also contemplated. A spa is also known in the industry as a hot tub and is generally formed of a concave shell to receive and contain water. Structures, such as a jet, can extend through the concave shell to move water from a surface outside the spa to a surface inside the spa or shell. Surfaces inside the shell are referred to as more “proximal” while surfaces that extend through the shell are referred to as “distal.” A proximal side of a jet faces the spa shell where the user relaxes, and the jet can provide hydrotherapy to the user in the spa.

In one embodiment, the terms “about” and “approximately” refer to numerical parameters within 10% of the indicated range. The terms “a,” “an,” “the,” and similar referents used in the context of describing the embodiments of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the embodiments of the present disclosure and does not pose a limitation on the scope of the present disclosure. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the author(s) of this disclosure for carrying out the embodiments disclosed herein. Of course, variations on these described embodiments will become apparent to those of ordinary skill in the art upon reading the foregoing description. The author(s) expects skilled artisans to employ such variations as appropriate, and the author(s) intends for the embodiments of the present disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of this disclosure so claimed are inherently or expressly described and enabled herein.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. An integrated connector for securing an interchangeable jet module within a spa, the integrated connector comprising:
a first portion defining a void for receiving a water connector disposed at a bottom of the interchangeable jet module, the first portion forming a bulkhead fitting; and
a second portion extending vertically from the first portion, the second portion having an engagement feature that is capable of engaging the interchangeable jet module with sufficient force to keep the interchangeable jet module locked onto the integrated connector in a locked position and ejected in an unlocked position, the interchangeable jet module capable of being changed from the locked position to the unlocked position without tools; and
the integrated connector disposed in a hollow of the spa, where the interchangeable jet module is secured within the hollow through the integrated connector.

2. The integrated connector of claim 1, wherein the engagement feature of the second portion comprises a hook.

3. The integrated connector of claim 2, wherein the hook comprises lateral wings, each lateral wing extending from a top of the second portion and each lateral wing being shaped to engage a back of the interchangeable jet module.

4. The integrated connector of claim 3, wherein each lateral wing engages a protrusion on the back of the interchangeable jet module.

5. The integrated connector of claim 1, wherein the first portion is substantially circular with the void defined about a center of the first portion.

6. The integrated connector of claim 5, wherein the first portion is substantially torus-shaped.

7. The integrated connector of claim 5, wherein the first portion further comprises a ramp to facilitate connection of the water connector of the interchangeable jet module within the void.

8. The integrated connector of claim 1, wherein the second portion is substantially rectangular extending between a bottom end and a top end, the engagement feature being incorporated into the top end.

9. The integrated connector of claim 1, wherein the second portion is substantially rectangular, extending between a bottom end and a top end, and has a curvature substantially matching a back of the interchangeable jet module.

10. A system for securing an interchangeable jet module within a spa, the system comprising:
an integrated connector comprising:
a first portion defining a void for receiving a water connector disposed at a bottom of the interchangeable jet module; and
a second portion extending vertically from the first portion, the second portion having an engagement feature for engaging the interchangeable jet module.

11. The system of claim 10, further comprising a gasket in connection with the first portion, the gasket positionable between the first portion of the integrated connector and the water connector of the interchangeable jet module.

12. The system of claim 10, wherein the first portion is substantially torus-shaped with the void defined about a center of the first portion.

13. The system of claim 10, wherein the first portion and the second portion form a unitary structure.

14. The system of claim 10, wherein the engagement feature comprises lateral wings, each lateral wing extending from a top of the second portion and each lateral wing being shaped to engage the interchangeable jet module.

15. The system of claim 10, wherein the integrated connector disposed in a hollow of the spa, where the interchangeable jet module is secured within the hollow through the integrated connector.

16. An interchangeable jet module for installation within a spa, the interchangeable jet module comprising:
a manifold comprising a plurality of air and water chambers;
a jet plate connected to the manifold and comprising a plurality of jets for delivering air and water from the plurality of air and water chambers into the spa;
a lock integrated at a bottom of the manifold, the lock for selectively engaging a bulkhead fitting of the spa; and
a gasket in association with the bulkhead fitting, the gasket for sealing a connection between the manifold and the bulkhead fitting of the spa.

17. The interchangeable jet module of claim 16, wherein the lock comprises a ball grab for engaging with a ball stud of the bulkhead fitting.

18. The interchangeable jet module of claim 17, wherein the ball grab engages the ball stud with a press-fit and the ball grab releases the ball stud through an actuated release.

19. The interchangeable jet module of claim 16, wherein the lock comprises a water connector for engaging the bulkhead fitting of the spa.

20. The interchangeable jet module of claim 16, wherein the interchangeable jet module further comprises a protrusion on a back of the manifold for engaging an engagement feature extending vertically from the bulkhead fitting.
